(19) United States
(12) Patent Application Publication
(10) Pub. No.: US 2007/0154722 A1
(43) Pub. Date: Jul. 5, 2007

(54) Durable, impact-resistant shelf

(76) Inventors: Robert M. Abel, Rosebush, MI (US); William E. Carpenter, Midland, MI (US); Robert E. Hacker, Farwell, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/325,932

(22) Filed: Jan. 5, 2006

(51) Int. Cl. B32B 27/40

(52) U.S. Cl. 428/423.1

(57) ABSTRACT

A damage-resistant storage shelf for institutional, industrial and commercial use, which is simple and inexpensive to manufacture, and which provides a surface that absorbs impact and prevents damage to items being stored on the shelf, even during rough handling of such items during placement and/or removal from the shelf includes a rigid, solid, cellulosic/polymeric composite board, and an impact-absorbent film adhered to, and covering, substantially the entire upper surface of the board. Preferably, the film is an elastomeric polyurethane and/or polyurea that is sufficiently thick to provide impact protection that reduces damage both to the shelf and items impacted against the shelf during placement thereon or removal therefrom.

### FIELD OF THE INVENTION

This invention relates to the field of storage and shelving, and more particularly to durable, impact-resistant shelving for institutional, industrial, and commercial use.

### BACKGROUND OF THE INVENTION

Shelves used in storage systems designed for various high traffic applications which may be subject to abusive treatment need to be durable, inexpensive, and, at the same time, should desirably have an impact-absorbent surface that minimizes damage to articles being stored on the shelf.

U.S. Pat. No. 4,826,265 discloses a shelving system for musical instrument storage which includes a top synthetic resin member having a plurality of back to front strengthening ribs and grooves, and a bottom synthetic member having a plurality of strength providing dimples, in which the grooves and dimples are fused together to provide additional strength.

### SUMMARY OF THE INVENTION

This invention satisfies the need for a damage-resistant storage shelf for institutional, industrial and commercial use, which is simple and inexpensive to manufacture, and which provides a surface that absorbs impact and prevents damage to items being stored on the shelf, even during rough handling of such items during placement on and/or removable from the shelf.

The shelves of this invention comprise a rigid, solid, cellulosic/polymeric composite board, and an impact-absorbent film adhered to, and covering, substantially the entire upper surface of the board.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view of a storage unit employing the shelves of the invention.

FIG. 2 is a side view of a shelf shown in FIG. 1.

FIG. 3 is a cross section view along lines III-III of FIG. 1.

### DETAILED DESCRIPTION OF PREFERRED EMBODIMENTS

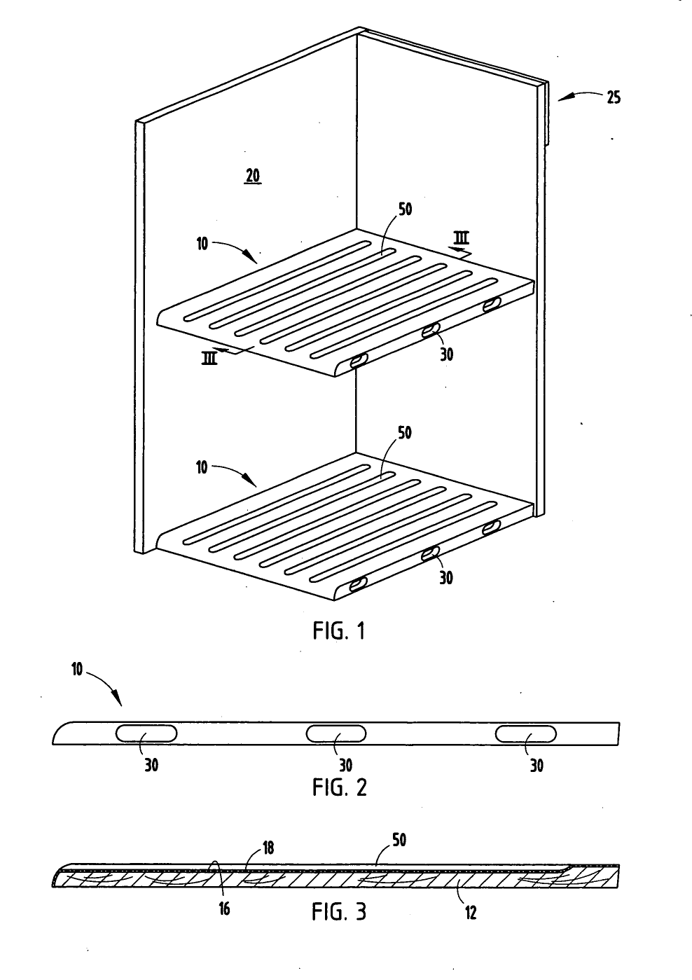

Shown in FIG. 1 is a perspective view of a shelf 10 incorporating features of the invention.

Shelf 10 includes a rigid, solid, cellulosic/polymeric composite board 12 (FIG. 3) having an upper surface 16, and an impact-absorbent film coating 18 adhered to, and covering, substantially the entire upper surface 16 of board 12.

Cellulosic/polymeric composite board 12 includes cellulosic fibers distributed in and/or adhered together by a polymer matrix. Cellulosic fibers include various wood fragments, chips, fibers, particles, sawdust, ground wood, wood flour, as well as other cellulosic fragments, flakes, particles, etc., such as alfalfa, wheat pulp, rice hulls, coconut shells, peanut shells, bamboo fiber, palm fiber, kanaf, etc.

Examples of suitable polymers that can form the matrix or binder material of the composite board include high density polyethylene, polypropylene, polyvinylchloride, low density polyethylene, chlorinated polyvinyl chloride, acrylonitrile butadiene styrene (ABS), ethyl-vinyl acetate, etc. Suitable cellulosic/polymer composite boards typically comprise from about 30% to about 60% by weight cellulosic filler, with the balance comprising the polymer matrix and any optional additives, such as fillers, pigments, UV stabilizers, etc.

Board 12 is of sufficient thickness so that it is relatively rigid. More specifically, a suitable thickness is selected for a given shelf length and width, so that for a selected cellulosic/polymer material, there is less than a 1% deflection upon application of a 50 pound weight to the center of a board supported at opposite lateral edges. Board 12 is also substantially solid, meaning that it does not have any large internal voids or hollow volumes. However, this does not exclude minor imperfections, such as occasional voids on the order of a few millimeters or less. Typically, board 12 has a thickness of from about 10 to 26 millimeters.

Film coating 18 typically covers substantially the entire upper surface of board 16, and is continuously adhered to board 16 over substantially the entire surface thereof. Film 18 may be applied as a liquid or powder coating that is sprayed, brushed, or otherwise suitably applied to the upper surface of board 12. Film coating is sufficiently thick to provide impact protection that reduces damage both to the shelf and items impacted against the shelf during placement thereon or removal therefrom. A suitable film thickness is typically in the range from 10 μm to 3000 μm (3 mm), preferably 50 μm to 1000 μm.

Film 18 is preferably an elastomeric film that provides impact-absorption properties to prevent damage both to shelf 10 and to any articles that are impacted against the upper surface of shelf 10 during loading or unloading of the article. Preferred elastomeric films include elastomeric polyurethanes, polyureas and combinations thereof. Preferably, the films are applied in the form of a coating composition that does not contain any volatile organic compounds or chlorofluorocarbons. Desirably, the film composition contains ultraviolet absorbers/stabilizers, exhibits high impact and abrasion resistance, and is waterproof.

In order to facilitate mounting of shelves 10 on sidewalls 20 of a storage unit 25, recesses 30 can be provided in lateral edges of shelf 10 to engage interfitting projections (not shown) from sidewall 20.

In the illustrated embodiments, a series parallel grooves 50 extending from the front edge toward the rear edge of shelf 10 may be formed into the upper surface of board 12. The subsequently applied polymer film 18 has a substantial uniform thickness that conforms with the contours of the upper surface of board 12, whereby the finished shelf 10 is provided with grooves that aid in air circulation and can collect and drain off any moisture, such as precipitation that may have collected on an article stored on shelf 10.

The above description is considered that of the preferred embodiment only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A shelf comprising:
a substantially rigid, solid cellulosic/polymeric composite board having an upper surface; and
a polymer film coating adhered to, and covering, substantially the entire upper surface of the board.

2. The shelf of claim 1, wherein the board has a thickness of from 10 mm to 26 mm.

3. The shelf of claim 1, wherein the polymeric film coating is a polyurethane.

4. The shelf of claim 1, wherein the polymeric film coating is a polyurea.

5. The shelf of claim 1, wherein the polymer film coating is a polyurethane/polyurea blend.

6. The shelf of claim 1, wherein the polymer film coating is an elastomeric film.

7. The shelf of claim 1, wherein the film coating has a thickness of from 10 μm to 3000 μm.
